(19) United States
(12) Patent Application Publication
(10) Pub. No.: US 2003/0230065 A1
(43) Pub. Date: Dec. 18, 2003

(54) Clutch engagable, in-line, lawn trimmer attachment

(76) Inventor: Russell David Hennum, Harpers Ferry, IA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/172,432

(22) Filed: Jun. 13, 2002

(51) Int. Cl. A01D 69/00

(52) U.S. Cl. 56/12.7; 56/11.9

(57) ABSTRACT

A trimmer apparatus for a lawn mower uses a drive sprocket mounted on the lawn mower cutting blade shaft and adapted for rotating a driven sprocket mounted on a trimmer shaft. The trimmer shaft is supported for rotation by a mounting bracket supported from one side of a housing of the lawn mower. The drive sprocket is engaged with the driven sprocket by a rotational motion transfer device. A string trimmer head is engaged with a clutch adapted for moving the string trimmer head into and out of engagement with the trimmer shaft, so that the string trimmer head may be engaged for rotation with the driven sprocket.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

### FIELD OF THE INVENTION

This invention relates generally to lawn trimming devices and more particularly to an in-line lawn trimming attachment with power takeoff from a lawn mower driven shaft and featuring a clutch for engagement and disengagement of the trimmer.

### DESCRIPTION OF RELATED ART

The following art defines the present state of this field:

Tihonovich, U.S. Pat. No. Des. 359,291 describes a mower with line weeder/trimmer attachment design.

True, U.S. Pat. No. 2,771,730 describes a lawn mower and trimmer which comprises, in combination, a wheeled carriage having at least one inset leading wheel, an elongated blade rotatably mounted under said carriage in grass-cutting relationship to cut a swath through a lawn, an elongated rotatable pivoted arm mounted laterally on said carriage on the side of said inset leading wheel, said rotatable pivoted arm being provided with means for rotating said rotatable pivoted arm about its longitudinal axis, a rotatable trimmer blade carried on said pivoted arm adjacent the inset wheel in advance of said elongated blade, power means mounted on said carriage in spaced apart relationship from said elongated blade for rotating said blades, a first belt operatively connecting said power means to said elongated blade, a second belt operatively connecting said power means to said trimmer blade, means connected to said pivoted arm for pivoting said pivoted arm upwardly in a vertical plane to loosen said second belt and disengage said trimmer blade from said power means, guide means on said carriage in operative relationship with said second belt for maintaining said second belt in operative connection with said power means comprising a roller under said second belt and a guide member above said second belt an idler pulley mounted on said carriage in rotatable contact with said first belt for maintaining said first belt in tension for rotating said elongated blade, and means connected to said idler pulley for moving said idler pulley into and out of contact with said first belt, said blades cutting a substantially continuous swath of a width greater than the width of the swath cut by said elongated blade when said trimmer blade is trimming and edging simultaneously in a common horizontal plane with the rotating elongated blade by rotating said pivoted arm about its longitudinal axis to place the trimming blade in said horizontal plane.

Gates, U.S. Pat. No. 5,065,566 describes a flexible line trimmer attachment for a tractor driven mower deck for trimming around trees and other objects simultaneously with mowing. A pivotal boom projects laterally from the mower deck and carries one or more trimming heads which rotate flexible lines using motive power supplied by the tractor. The boom deflects when it encounters a tree and is able to trim around more than 180.degree. of the tree circumference. A tension spring returns the boom to its normal lateral position after the tree has been cleared. The boom can be swung upwardly for compact storage by a power cylinder.

Wassenberg, U.S. Pat. No. 5,174,100 describes a combination mower/trimmer apparatus comprising a mower with a body, a driven horizontally oriented blade member, and a trimmer assembly. The trimmer assembly includes a pair of spools for dispensing flexible trimming lines, guides for directing the lines along the blade member, an activating assembly for extending and retracting the trimming lines, and a line for feeding assembly to supply additional line during use. The apparatus includes a pair of pivotally mounted guards which normally seek an elevated position but which assume a lowered position when the respective guard is urged against an obstacle whereby a generally horizontal elongate slot in that guard aligns with a similar slot in the mower body such that extended trimming lines simultaneously trim vegetation along the obstacle as the blade member mows the vegetation adjacent thereto.

Devillier et al., U.S. Pat. No. 5,560,189 describes a mower assembly for cutting, trimming, and edging a lawn. The inventive device includes a mower assembly hainv a blade rotating within a horizontal plane for cutting grass. A trimmer assembly extends laterally of the mower assembly for trimming grass. An edger assembly similarly projects laterally of the mower assembly and includes an edging blade rotating in a vertical plane for cutting grass adjacent a solid object.

Fassauer, EP 0514209 A1 describes an air-floated apparatus for use as a lawn mower or vacuum cleaner. In one embodiment, the apparatus comprises a housing having an outer shroud and an inner shroud, the outer shroud surrounding a predetermined portion of the inner shroud to define a pressure chamber between the inner and outer shrouds and a vacuum chamber within the inner shroud. A drive mechanism includes a motor having a rotatable shaft. A single impeller is supported in the pressure chamber and rotates on the shaft for exhausting air from the vacuum chamber to erect grass underlying the opening while simultaneously pressurizing air in the pressure chamber to float the apparatus above the grass. Airborne cut grass clippings are vacuumed into and through the impeller for distribution into the soil for recycle and recut. According to the invention, an adjustment assembly is provided for adjusting a position of the housing relative to a center-line auxiliary wheel assembly. The air-floated wheeled apparatus may include an edger and a trimmer. The prior art teaches lawn edgers and trimmers mounted on lawn mowers including attachments for existing lawn mowers, but does not teach an attachment with a simplified clutch arrangement as taught in the present invention. The present invention fulfills these needs and provides further related advantages as described in the following summary.

### SUMMARY OF THE INVENTION

The present invention teaches certain benefits in construction and use which give rise to the objectives described below.

A string-type trimmer apparatus for a lawn mower uses a drive sprocket mounted on the lawn mower cutting blade shaft and adapted for rotating a driven sprocket mounted on a trimmer shaft. The trimmer shaft is supported for rotation by a mounting bracket supported from one side of a housing of the lawn mower. The drive sprocket is engaged with the driven sprocket by a rotational motion transfer device. A string trimmer head is engaged with a clutch adapted for moving the string trimmer head into and out of engagement with the trimmer shaft, so that the string trimmer head may be engaged for rotation with the driven sprocket.

A primary objective of the present invention is to provide an apparatus and method of use of such apparatus that provides advantages not taught by the prior art.

Another objective is to provide such an invention capable of being mounted onto a lawn mower for trimming and edging a lawn.

A further objective is to provide such an invention capable of being engaged and disengaged at will through a manually operated and simplified clutch arrangement.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention showing a trimmer device of the invention at one side of a lawn mower;

FIG. 2 is a perspective view thereof showing drive and driven sprockets of the invention and means for rotational motion transfer as a drive belt;

FIG. 3 is an exploded view of a trimmer drive and clutch thereof, and

FIG. 4 is an exploded view of a further embodiment thereof showing the motion transfer means as a drive shaft.

### DETAILED DESCRIPTION OF THE INVENTION

The above described drawing figures illustrate the invention in at least one of its preferred embodiments, which is further defined in detail in the following description.

The present invention is a lawn maintenance apparatus comprising in combination: a lawn mower 10, having a drive sprocket 20 mounted on the lawn mower's cutting blade shaft 25, which is powered in rotational motion by the mower's engine 15, and rotates with it. A driven sprocket 30 is mounted on a trimmer shaft 40, which is held in place for rotation in upper bearing 84′. The upper bearing 84′ is supported for rotation and is mounted within a bearing housing 89, onto a mounting bracket 50 engaging and extending from a housing 60 of the lawn mower 10. These parts are engaged and assembled using common hardware as is shown and well known. The drive sprocket 20 is engaged with the driven sprocket 30 by a means for rotational motion transfer 70, and a string trimmer head 80 is engaged with a clutch 90 adapted for moving the string trimmer head 80 into and out of engagement with the driven sprocket 30. In this manner the string trimmer head 80 may be engaged for rotation with the driven sprocket 30 for spinning stings 83, as well as disengaged when desired.

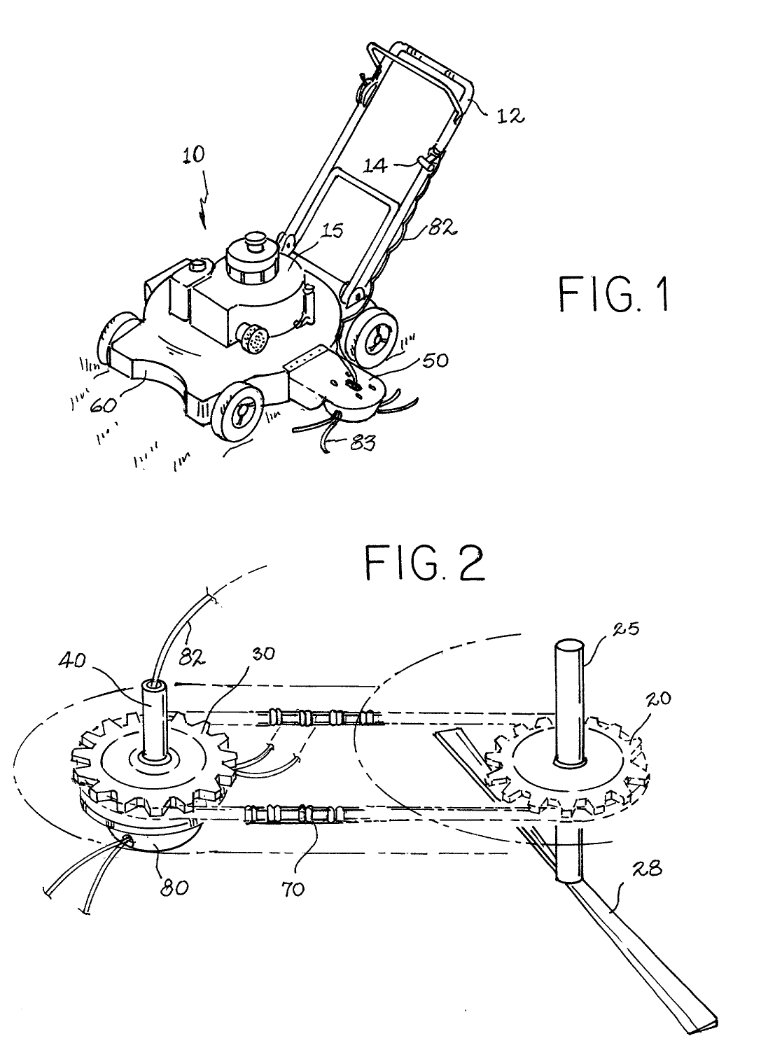

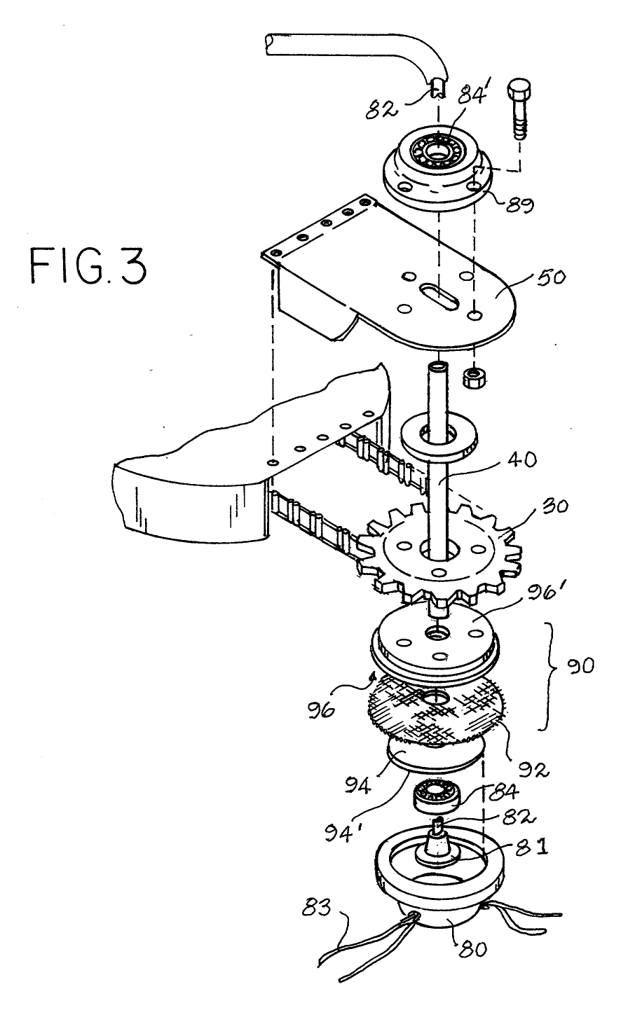

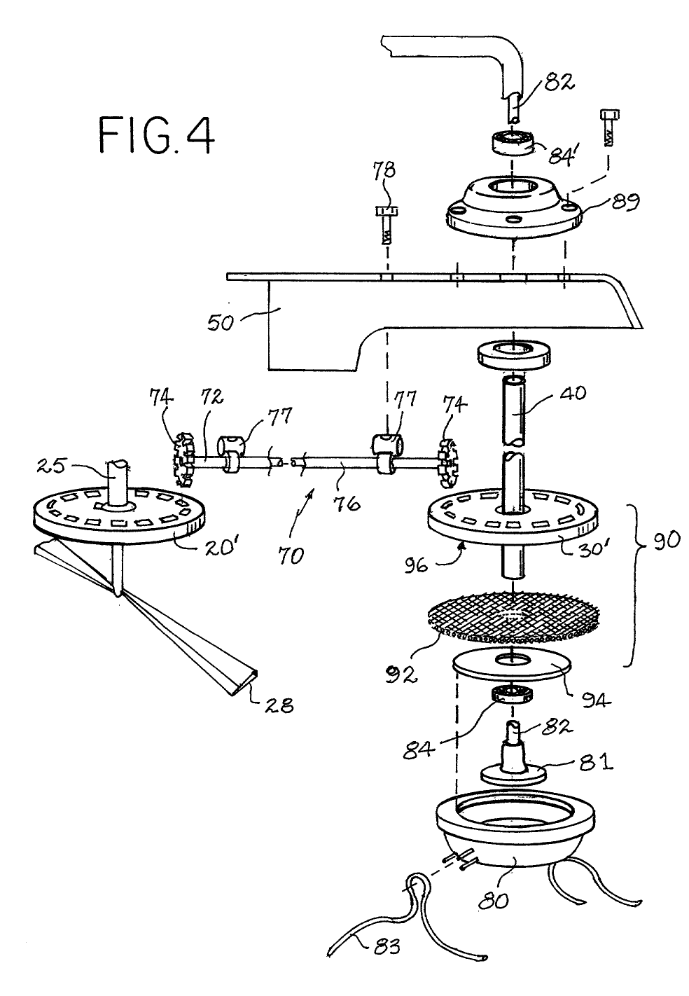

The motion transfer means 70 is preferably a drive belt, as shown in FIGS. 2 and 3, or a shaft assembly, as shown in FIG. 4. Such a shaft assembly preferably comprises small sprockets 74, which engage sprockets 20′ and 30′ and which are rotationally engaged at the ends of 10 drive shaft 72. Tube mount 76 is secured to mounting bracket 50 using fasteners 77 and 78 and drive shaft 72 is securely held by, and rotates, within it thereby providing an alternate manner of transferring rotational energy from shaft 25 to shaft 40.

Preferably, the clutch 90 comprises a clutch pad 92 sandwiched between opposing surfaces 94 and 96. In FIG. 3 the surfaces 94 and 96 are part of clutch plates 94′ and 96′. In FIG. 4, sprocket 30′ acts as one of the clutch plates. The clutch plates are able to be drawn toward each other and into contact on opposing sides of clutch pad 92 to enable the string trimmer head 80 to rotating with trimmer shaft 40 without interrupting lawn mowing action provided by cutting blade 28. Referring now to FIG. 3, preferably, a flexible coaxial cable 82, such as is used commonly for bicycle brakes, is engaged with the string trimmer head 80 and is adapted for drawing the head 80, head engagement plate 81, which is secured to head 80, bearing 84, clutch plate 94′ and clutch pad 92, into contact with clutch plate 96′, which is mounted to driven sprocket 30, the opposing surfaces 94 and 96 acting frictionally on clutch pad 92 for bringing head 80 into rotation. It should be noticed that trimmer shaft 40 rotates constantly, but head 80 may be rotating or not depending upon selection by the operator through an operating control means 14 mounted on a handle 12 of the lawn mower 10 as shown in FIG. 1. The control means 14 may be a simple lever or caliper as is known in the art.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A trimmer apparatus for a lawn mower, the apparatus comprising: a drive sprocket mounted on the lawn mower cutting blade shaft for rotating therewith; a driven sprocket mounted on a trimmer shaft for rotating therewith, the trimmer shaft supported for rotation by a mounting bracket adapted for engagement with a housing of the lawn mower; the drive sprocket engaged with the driven sprocket by a means for rotational motion transfer; a string trimmer head engaged with a clutch adapted for moving the string trimmer head into and out of engagement with the trimmer shaft, whereby the string trimmer head may be selectively engaged for rotation with the driven sprocket.

2. The apparatus of claim 1 wherein the motion transfer means is a drive belt.

3. The apparatus of claim 1 wherein the motion transfer means is a shaft with means for right-angle drive engagement with the drive and the driven sprockets.

4. The apparatus of claim 1 wherein the clutch comprises a clutch pad sandwiched between opposing surfaces.

5. The apparatus of claim 4 wherein a flexible cable is engaged with the string trimmer head and adapted for drawing the opposing surfaces into contact with the clutch pad through an operating control means.

6. A lawn maintenance apparatus comprises in combination: a lawn mower having a drive sprocket mounted on a cutting blade shaft of the lawn mower for rotating therewith; a driven sprocket mounted on a trimmer shaft for rotating therewith, the trimmer shaft supported for rotation by a mounting bracket engaging a housing of the lawn mower; the drive sprocket engaged with the driven sprocket by a means for rotational motion transfer; and a string trimmer head engaged with a clutch adapted for moving the string trimmer head into and out of engagement with the driven sprocket, whereby the string trimmer head may be engaged for rotation with the driven sprocket.

7. The apparatus of claim 6 wherein the motion transfer means is a drive belt.

8. The apparatus of claim 6 wherein the motion transfer means is a shaft with means for right-angle drive engagement with the drive and the driven sprockets.

9. The apparatus of claim 6 wherein the clutch comprises a clutch pad sandwiched between opposing surfaces.

10. The apparatus of claim 9 wherein a flexible cable is engaged with the string trimmer head and adapted for drawing the opposing surfaces into contact with the clutch pad through an operating control means.
